(19) United States
(12) Patent Application Publication
(10) Pub. No.: US 2023/0252431 A1
(43) Pub. Date: Aug. 10, 2023

(54) SYSTEM AND METHOD FOR DECENTRALIZED WEB PAGE OR WEB APPLICATION OWNERSHIP ASSIGNMENT USING DOMAIN NAMES AND NON-FUNGIBLE TOKENS

(71) Applicant: Mohammed Zaman Mecci, Round Rock, TX (US)

(72) Inventor: Mohammed Zaman Mecci, Round Rock, TX (US)

(21) Appl. No.: 18/103,548

(22) Filed: Jan. 31, 2023

Related U.S. Application Data
(60) Provisional application No. 63/306,544, filed on Feb. 4, 2022.

(51) Int. Cl. G06Q 20/06; G06Q 50/18

(52) U.S. Cl. CPC G06Q 20/065; G06Q 50/184

(57) ABSTRACT

A method for web page and web application ownership assignment comprising assigning one or more owners an ownership to a web page or a web resource application using one or more web proof of ownership technologies which include a digital rights management, a digital watermark, a fingerprinting and a generation of a hash from an information associated with the web page or the web application and a generation of a software code. Web resources corresponding to the web page or the web application are encrypted with generation of a set of encryption and decryption keys. Then pairing or tagging the web page or the web application or the web resource is done with a decentralized domain name service smart contract and one or more Non-Fungible Tokens. Pairing or tagging involves pairing of a domain and a subdomain corresponding to the web page or the web application or the web resource.

### REFERENCE TO RELATED APPLICATIONS

This application claims the benefit of U.S. Provisional Application No. 63/306,544, filed Feb. 4, 2022, the contents of which are incorporated herein by reference.

### FIELD OF THE INVENTION

This present invention generally relates to assigning ownership to internet web pages and applications. More particularly, the present invention relates to using blockchain infrastructure for creating decentralized ownership and monetization of web apps.

### BACKGROUND OF THE INVENTION

A domain name generally identifies a network domain or represents an Internet Protocol (IP) resource and is used by people to access that network domain or that IP resource such as a website. Domain name system provides easy to remember domain names instead of the complicated Internet Protocol address of the resources. Every domain name is registered with a domain name registry which establishes ownership of that particular domain name. Since there cannot exist two exactly similar domain names each domain name carries an intrinsic value. Sometimes, highly sought-after domain names are traded through the secondary market. The domain names and corresponding sub-domain names are owned by individuals or companies. Any web application tied to the domain name becomes an asset of the individual or an entity or company that owns the asset. Presently, it is not possible to have a decentralized ownership of the internet web page or web application. In other words, it is not possible to assign multiple direct owners of an internet web application and to monetize each web page or category or sub-domains tied to web pages offering different categories of products and services.

Emergence of blockchain technology has enabled blockchain based domain name transactions. Blockchain is a distributed ledger that can record transactions verifiably and cannot be tampered. A blockchain stores a registry of transactions and records across a peer-to-peer network in a growing list of records, referred to as blocks which are linked using cryptography. Each block can contain a cryptographic hash of the previous block, a timestamp, and transaction data. While use of blockchain mechanism has provided a general automated transaction system for domain name transactions independent of the domain name registrar and domain name registrar systems, and is transparent and non-tamperable, existing art does not allow a domain name owner to fully utilize the commercial potential of the subdomains and extended URLs and the corresponding web pages under the domain names or sub domain names they own.

In the context of blockchain technology, “Non-Fungible Token” (NFT), which is a cryptographic token that represents verifiable proof of ownership of unique items. Some of the examples of NFTs that exist today are “a unique digital artwork, a unique sneaker in a limited-run fashion line, an essay, a domain name, a game, and an event ticket. Monetization of the existing NFTs for objects like digital art, collectables or virtual land is limited. With few exceptions, the same is true with blockchain domain names and gaming NFTs. Presently, the key factor that attracts investors to buy these NFTs is their supposed future value i.e. the chance to sell them at higher price. But there is a limited recurring revenue model for monetization of NFTs or their associated objects except from its sale or from a specific product like the gaming NFT listed on a platform. There is no decentralized ownership model for web applications/platforms/marketplaces using their associated sub-domains and URLs.

Thus, there exists a need for a system and method that overcomes the aforementioned disadvantages associated with the existing centralized ownership of web applications with respect to creating a decentralized ownership of web applications and monetization of web pages or categories corresponding to subdomains and extended subdomain, URLs of a domain.

### OBJECTS OF THE INVENTION

An object of the present invention is to provide a system and method for assigning decentralized and distributed ownership of web pages, web platforms, marketplaces and software applications to individual owners, group owners or organizations.

Another object of the present invention is to provide a system and method for monetization of standalone web pages within a web application.

Yet another object of the present invention is to provide a system and method for revenue sharing on transactions made through web pages of lower-level subdomain with an owner of an upper-level domain of domain hierarchy.

Still another object of the present invention is to enable assigning of individual or group ownership of web pages or websites or marketplace or platform or software application corresponding to categories and subcategories of a parent or primary website or marketplace or platform resulting in decentralized ownership.

Another object of the present invention is to provide a system and method for generating recurring revenue from the sale of products, services and advertisement space listed under sub-domains, URLs and categories of a website or marketplace or a platform.

These and other objects of the present invention are apparent upon inspection of this specification, including the drawings attached hereto.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Present invention is directed to an internet web page ownership and monetization system and method. The internet web page is used to sell a range of services or product or data or software or information offered through a web page of a website. A website or application may comprise many subcategories. Each of such subcategories of product or service or data or software or information can have a separate web page having a unique domain, sub-domain, web address or URL (Uniform Resource Locator). Such web addresses or URLs of the web pages for the subcategories comprise a subdomain or a subdirectory of the domain name on which the main parent web page is linked. Present invention allows the owner of a website or web application to enlist the individual web pages corresponding to the subdomains/extended subdomains URLs/subdirectories of such domain for sale, creating a decentralized ownership of web applications like an e-commerce marketplace. Prospective buyers may bid for ownership of the web pages corresponding to such subdomains/extended subdomain URLs/subdirectories. The winning bidder is assigned the ownership of the respective web page by minting sub-domains on a crypto name service (CNS) within a backend blockchain infrastructure. A sub-domain is then paired with a web page using digital rights management technology or a software program or code. Subsequently, royalty/revenue for any transaction executed against a usage or utilization of any of the resources including but not limited to product listing, classifieds listing etc. listed on the web page can be automatically distributed by the smart contract between the parent domain owner and the subdomain owner. The subdomain owner can further assign ownership of web pages of subdomain/extended subdomain URL/subdirectory under the subdomain owned by him/her to new owner or a group of owners thus enabling a continuous source of income for the web page owner and each of the domain/subdomain/subdirectory owner up in the line of ownership as per the domain pyramid hierarchy.

### BRIEF DESCRIPTION OF THE DRAWINGS

In order to describe the manner in which features, and other aspects of the present disclosure can be obtained, a more particular description of certain subject matter will be rendered by reference to specific embodiments which are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 illustrates a block diagram representing an exemplary non-limiting operating environment in which one or more aspects of various embodiments described herein can be implemented;

FIG. 2 illustrates a block diagram representing an exemplary non-limiting use of blockchain infrastructure to assign ownership to the web pages and web applications paired with domain, sub-domain names and Uniform Resource Locator (URL’s) which one or more aspects of various embodiments described herein can be implemented.

FIG. 3 illustrates a block diagram representing an exemplary non-limiting method of monetizing an internet web page in which one or more aspects of various embodiments described herein can be implemented.

FIG. 4 illustrates a flow chart representing an exemplary non-limiting e-commerce shopping cart or a marketplace example use case with corresponding categories which one or more aspects of various embodiments described herein can be implemented.

FIG. 5 illustrates a flow chart displaying the general steps associated with the method for web page monetization in accordance with an embodiment of the present invention.

### DETAILED DESCRIPTION OF THE INVENTION

The following description is presented to enable any person skilled in the art to make and use the invention and is provided in the context of applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown but is to be accorded the widest scope consistent with the principles and features disclosed herein.

In the following detailed description, numerous specific details are set forth in order to provide a comprehensive understanding of the invention. However, it will be understood by those skilled in the art that the present invention may be practiced without these specific details. In other instances, well-known methods, procedures, and components have not been described in detail so as not to obscure the present invention.

Before discussing specific embodiments of the invention, some terms may be described first in detail. A website may comprise one or more interrelated web page files and folders and programs residing on one or more servers. A web page on the Internet is identified by a web address which contains information about the location of the web page. Different web addresses such as URLs (Uniform Resource Locators) are assigned respectively to each web page and each URL is the location of a specific web page or file on the Internet. Every URL is made up of multiple parts including domain name that represents the name of a website or web page and other information which are required to find that website/web page. Conventional domain name architecture allows use of a single domain name by a single entity only and such a licensee entity is commonly referred to as the “owner” of the domain. A domain hierarchy consists of root zone servers, top level, second level, one or more sub-domains and so on. The root is the highest level in the DNS hierarchy tree. The root zone DNS servers are operated by different organizations such as ICANN. The next level in the hierarchy is the top-level domain. The top-level domains are installed on the root zone DNS servers. For example .com or .org. The next level in the hierarchy is the second level domain. This is the main part of the domain and varies according to the buyer. (e.g. in www.example.com, “example” would be the second level domain of the “.com” top level domain). A subdomain is a domain that is part of the main domain. Suppose two domains, one.example.com and two.example.com. Here both the domains are the subdomains of the main domain example.com. In comparison to conventional domain name technology, the blockchain domain names follow a similar domain hierarchy. The domain name service in blockchain technology is known as the CNS (Crypto Name Service). It is a set of smart contracts on the blockchain protocol like Ethereum blockchain that govern how domains are created, used or transferred. Although it serves a similar purpose as a conventional DNS (Domain Name system), CNS has architectural differences that change the interaction model significantly. For example, CNS domains are owned irrevocably. They do not need to be renewed and cannot be reclaimed. Once claimed, users have complete control of their domains and the keys to access the domain.

Non-Fungible tokens or NFTs are tokens that represent provable ownership of unique items. Some of the examples of NFTs that exist today are “a unique digital artwork, a unique sneaker in a limited-run fashion line, an essay, a domain name, a game, and an event ticket. Fungible is an economic term that can be used to describe these NFTs. Prospective and current “Non fungible token” marketplaces issue cryptographically secured tokens that pair with a unique digital or physical product asset representing a value. Some examples of digital assets are digital art or internet domain names or physical assets like real estate. Each token represents as a whole or a portion or fractional ownership in an asset. Tokens can be held or sold by the owner representing in the transfer of ownership of the digital or physical and/or tangible or intangible asset.

The term smart contract is often used to refer to software programs that run on a blockchain. The smart contracts include executable codes which are registered, stored, and/or replicated on the blockchain. A transaction is an execution of the smart contract code which can be performed in response to conditions associated with the smart contract being satisfied. In the contest of the present invention, the code of the smart contract acts as a programmatically defined autonomous agent for digital rights management with its own persistent variables that gets executed by computer systems within the blockchain when the smart contract is referenced by a message and/or a transaction. Any modification to the blockchain ledger caused by the smart contract execution may be automatically replicated throughout the blockchain peers using one or more consensus protocols.

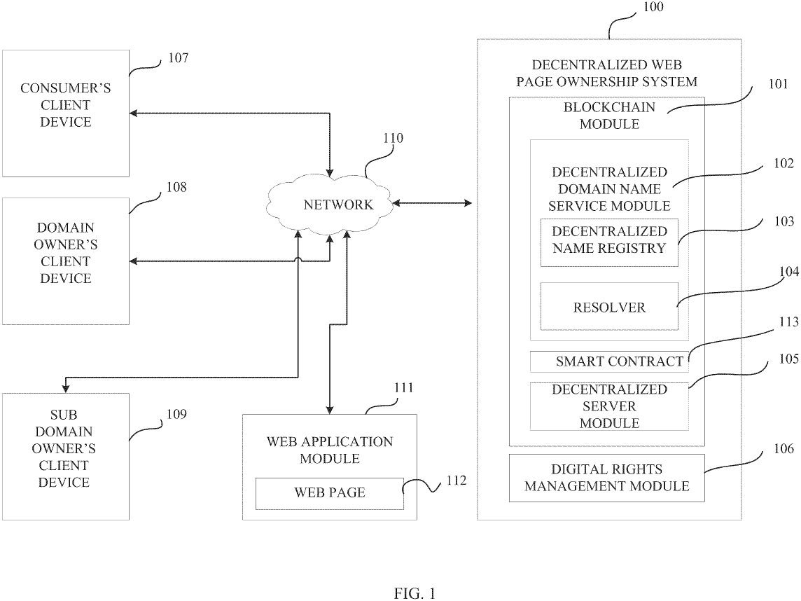

FIG. 1 illustrates the general architecture of a system 100 for decentralized web page ownership system or computer system that operates in accordance with one embodiment of the present invention. Three numbers of computing devices or client devices 107, 108 and 109, are shown connected to a web page decentralized ownership computer system 100 via a network. Although only three computing devices or client devices 107, 108 and 109 are illustrated in FIG. 1, it is to be understood that there can be a plurality of client devices connected to the computer system 100. The computer system 100 communicates with the client devices over the network 110. The user interface of the system for providing web page decentralized ownership and monetization services of the present invention can be presented on the client device through a web browser or through a native mobile application communicating with the computer system 100 and is used for displaying, entering and/or managing data and for interacting with the system. As used herein, the term “network” generally refers to any collection of distinct networks working together to appear as a single network to a user. The term also refers to the so-called world wide “network of networks” or Internet which is connected to each other using the Internet protocol (IP) and other similar protocols. As described herein, the exemplary public network of FIG. 1 is for descriptive purposes only and it may be wired or wireless. Although, the description may refer to terms commonly used in describing particular public networks such as the Internet, the description and concepts equally apply to other public and private computer networks, including systems having architectures dissimilar to that shown in FIG. 1. The inventive idea of the present invention is applicable for all existing cellular/telecommunication network topologies.

The graphical user interface (GUI) or user interface presented by the Web application 111 on the client devices through a web browser or mobile app may be utilized by the consumers client devices 117, 108, 109 for activities related to as signing up, logging in, purchasing any form of product or services, including reading, viewing content and for placing of bids for subdomain/categories etc. The web application 111 and underlining web pages 112 uses the blockchain module paired with digital rights management module to assign the ownership of the web pages to the domain owners 108 and subdomain owners 109.

The components appearing in the system 100 for providing decentralized web ownership services refer to an exemplary combination of those components that would need to be assembled to create the infrastructure in order to provide the tools and services contemplated by the present invention.

The blockchain module 101 is configured to operate as part of a decentralized web page ownership system 100, an example of which is shown in FIG. 1. The blockchain infrastructure module 101 may include a publicly managed (permissionless) blockchain infrastructure (such as Ethereum or the like) or a privately managed (permissioned) infrastructure (e.g., a blockchain managed by an organization).. Similarly, any of the client devices 107, 108 and 109 may also be configured to validate transactions submitted to the blockchain. Also, any of the client devices 107, 108 and 109 may be configured to execute transactions on the blockchain infrastructure 101. As is further discussed below, the transactions from the consumer client device 107 may include purchasing or subscribing to any product or service. Whereas the transactions from domain owner’s client device 108 and Subdomain owner’s client device 109 may include one or more of registration of subdomain, selling of a subdomain, buying of a subdomain, revenue sharing etc. Here, the consumer 107 is a person/entity who consumes/utilizes products and/or services offered through a web page 112. The domain owner or owner’s 108 and subdomain owner or owner’s 109 is a person/entity who owns the web page 112.

The computer system 100, in some embodiments, can be a node of the blockchain infrastructure and it performs processing steps for web page ownership. Computer system 100 may include one computer or multiple computers/nodes of the blockchain infrastructure. The decentralized server module 105 comprises computer processor, memory and storage disks and hosts the blockchain module 101 that comprises decentralized domain name service module 102. Decentralized domain name service module 102 includes a decentralized name registry and resolver that keeps track of domain name ownership as part of the overall blockchain module or system.

The web application module 111 is a system that sends out web pages containing electronic data files in response to Hypertext Transfer Protocol (HTTP or HTTPS) requests or similar protocol requests from remote browsers (i.e. browsers installed in the client devices) or in response to similar requests made through a mobile app or mobile application of the present invention installed on a client device. The web application 111 can communicate with the mobile app of the present invention and/or with a web browser installed on client devices 107, 108 and 109 to provide the user interface required for providing the decentralized web page ownership and web page monetization services.

Whereas the blockchain module 101 handles the processes for registration of domain/subdomain for a web page in the name of an owner, the digital rights management module 106 assigns the ownership of the web page to its owner. The blockchain module 101 communicatively interfaces the computer system 100 with other blockchain participating nodes and client devices so as to enable the computer system 100 to participate in the available blockchain protocols by acting as a blockchain protocol compliant node. This permits the computer system 100 to provide blockchain services to the other participating nodes and client devices.

The blockchain module 101 is configured to generate smart contracts 113 via a high-level application and programming language (Solidity, Ethereum for example) which can be deployed to a blockchain for execution by computer systems. In the context of both permissioned and permissionless blockchains, the term smart contract is often used to refer to software programs that run on a blockchain. The smart contracts include executable codes which are registered, stored, and/or replicated on the blockchain 100. A transaction is an execution of the smart contract code which can be performed in response to conditions associated with the smart contract being satisfied. In the contest of the present invention, the code of the smart contract acts as a programmatically defined autonomous agent for to assign ownership of the web page to its owners with its own recurring variables that gets executed by computer systems within the blockchain when the smart contract is referenced by a message and/or a transaction. Any modification to the blockchain ledger caused by the smart contract execution may be automatically replicated throughout the blockchain peers using one or more consensus protocols.

Although, the description of the system 100 for providing web page monetization services may refer to terms commonly used in describing particular computer servers, the description and concepts equally apply to other processing systems, including systems having architectures dissimilar to that shown in FIG. 1.

The decentralized domain name service module 102 of FIG. 1 is a distributed ledger name service system. Examples of decentralized name service 102 may include Ethereum Name Service (ENS) and Crypto Name Service (CNS) etc. The decentralized name service 102 comprises a decentralized blockchain name registry 103 and a blockchain resolver 104, both of which can be smart contracts implemented on blockchain. The blockchain domain registry 103 smart contract can maintain a mapping from the domain name of any level to an owner and to the blockchain resolver 104. The blockchain domain registry 103 is responsible for recording the owner. Resolver 104 is the smart contract that stores domain records and provides methods for domain resolution. Smart contracts such as “DomainZoneController” written in a contract-oriented, high-level programming language “Solidity” enables owners of a domain zone to mint subdomains. Subdomains can be minted, transferred or burned by both a direct owner and a domain zone owner (i.e. parent domain owner) for assigning ownership of subdomains to another entity.

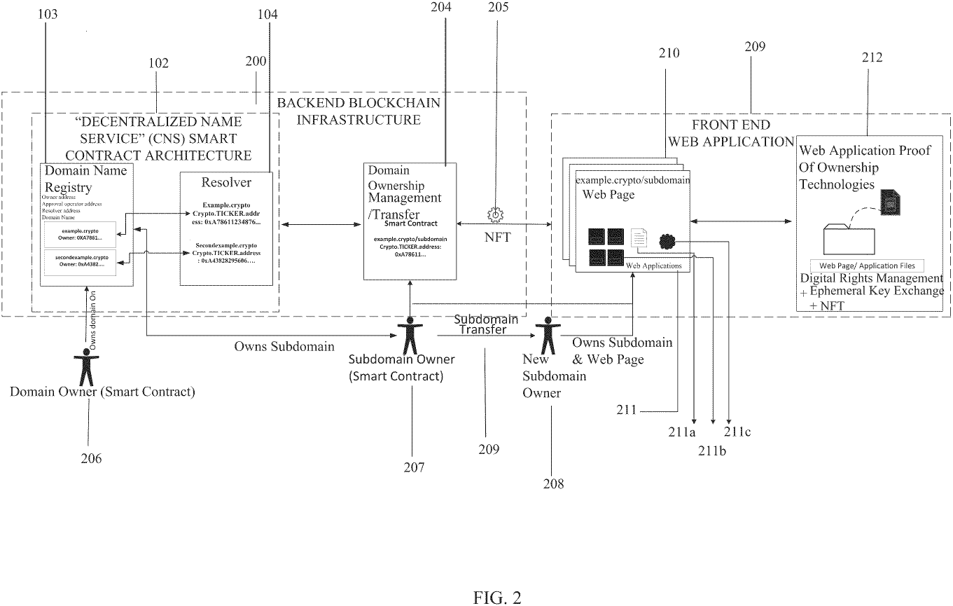

FIG. 2 illustrates the high-level architecture consisting of backend blockchain infrastructure 200 combined with front end web application 213. Crypto Name Service smart contract architecture 201 describes how domains are minted and managed, what information is stored and how users can interact with domains through blockchain. Crypto Name Service contains two central components called Registry 202 and Resolver smart contracts 203. Registry is used to mint new subdomain or transfer domain ownership. It defines the domain ownership rules and stores the metadata of all the domain names. The domain owners own a domain name using a registry. Registry is a map or a dictionary that stores owner address, resolver address and domain name. The Resolver is a smart contract that is used for resolving domain names and storing owner’s domain name records such as cryptocurrency addresses, chat IDs, and IPFS hashes for decentralized websites. The third component within the blockchain infrastructure is the domain management smart contract 204 also known as domain zone controller. New subdomains can be minted or sold or transferred 209 new buyers or owners 208 transferring the underlining web page ownership along with the subdomains to new owners.

Presented herewith is a novel and irrefutable “Web page Proof of Ownership” that pairs the blockchain infrastructure 200 components within the “Decentralized Name Service Smart Contract” 201 and the smart contract 204 and the “Non-Fungible Tokens (NFT’s) 205” with the internet web pages or web applications 210, 211a, 211b, 211c using web technologies 212 including but not limited to digital rights management and ephemeral key exchange to assign ownership to the web pages and underlining web applications 211 (211a, 211b, 211c) within the webpage for example ecommerce applications or marketplaces 211a, informational websites 211b and software/cloud applications 211c and the underlying digital or physical products listing or informational data listed under the domain or subdomains or URL’s paired with corresponding web pages.

FIG. 2 architecture makes it possible for a decentralized and distributed digital ownership of a single application like an e-commerce marketplace. For example, an e-commerce marketplace shopping.com though the multiple sub-domain and URL hierarchy shopping.com/books and shopping.coin/books/Fiction creates multiple sub-owners of the underlining web-page and resources listed within the web page. Owner “A” owns shopping.com, Owner “B” may own shopping.com/books and Owner C may own shopping.com/books/Fiction.

FIG. 2 architecture may be utilized by the users 206, 207, 208 for activities related to buying, selling, bidding, or transferring 209 a domain name or subdomain name or the URLs and the underlining web pages or web application or categories within the web applications through a website or a mobile app.

Web page or web application Proof of ownership 212 may further strengthen by the use of digital rights management methods and technologies like digital watermarks on a web page, fingerprinting on a web page, and encryption of the resources with generation of a set of encryption/decryption keys, generation of a hash from information associated with the resources, generation of contract/licensing information, time stamp and terms of ownership etc.

Although, the description of the system pairing the domain names to the web pages for providing web page monetization services may refer to terms commonly used in describing software application, the description and concepts equally apply to other web applications, including systems having architectures dissimilar to that shown in FIG. 2.

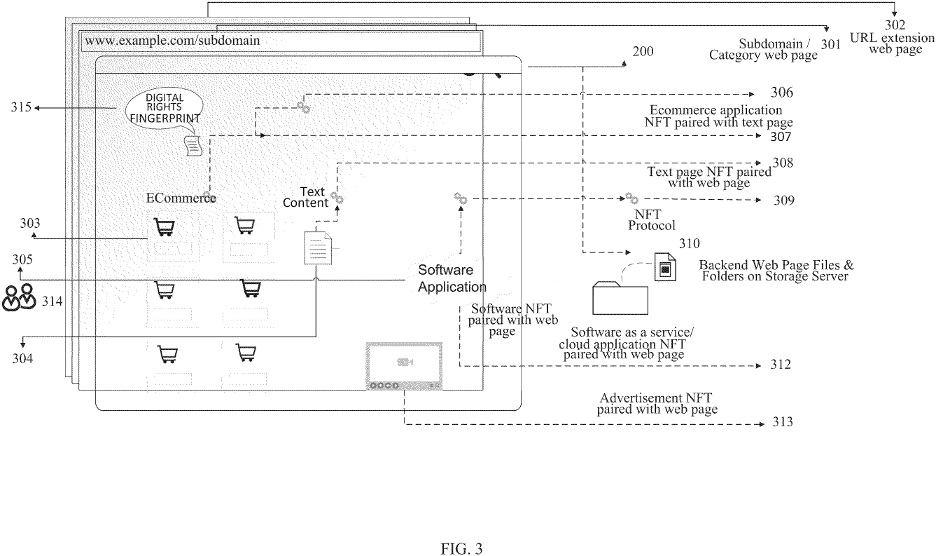

FIG. 3 illustrates different methods of monetizing a web page 300 and the corresponding applications in detail. In this example an ecommerce or a shopping page 303, an informational page 304, a software application 305 and an advertisement placement on page 313 are some of the example applications and methods to monetize the web page or a website. These web page applications are paired with a domain name 300 or a sub domain 301 or a domain URL 302. The methods described generate revenue streams to the owners or a group of owners of the web page or category page assigned to a domain, sub-domain, and a URL. The blockchain infrastructure uses the following one or more combination of domain names. Blockchain domain extensions like .Eth or .crypto and DNS names like .com or .org, subdomains, web URLs, paired with webpage code files and folders 310, and/or a software webpage code snippet and a combination of web technologies like digital rights fingerprinting 315 and NFT based smart contract protocol 306 like Ethereum ETH 721 or ERC 1155 or Hyperledger to authenticate and transact the ownership of the web page or multiple web pages creating a decentralized ownership of the web applications. The webpage could represent an ecommerce marketplace web page 303 (example: amazon.com/books, ebay.com/fashion), or a store, or any type of web platforms (example: Airbnb, Upwork, craigslist) or a content publishing website 304 like news website (example: cnn.com). There are a variety of use cases and monetization opportunities for web page or category, or subdomain or URL owners tied to a web page or application within a webpage that generates recurring income and job opportunities for individuals and businesses.

In the following description, a method of web page ownership and monetization in accordance with one embodiment of the present invention is explained with the help of an example with reference to the FIGS. 1 to 2. In the present example, a person or a group or an entity 314 owns a website www.example.com with a domain (also referred to as second level domain) named “example” and a top-level domain (TLD) “.com” as shown at box 300 of FIG. 3. Present invention is applicable to both conventional ICANN (Internet Corporation for Assigned Names and Numbers) coordinated DNS TLDs (such as .com, for example) and blockchain based TLDs (such as. eth or. crypto, for example). The blockchain domain name registry 202 maintains a mapping of this domain “example” to owner 314 and to the blockchain resolver 203 as in FIG. 2.

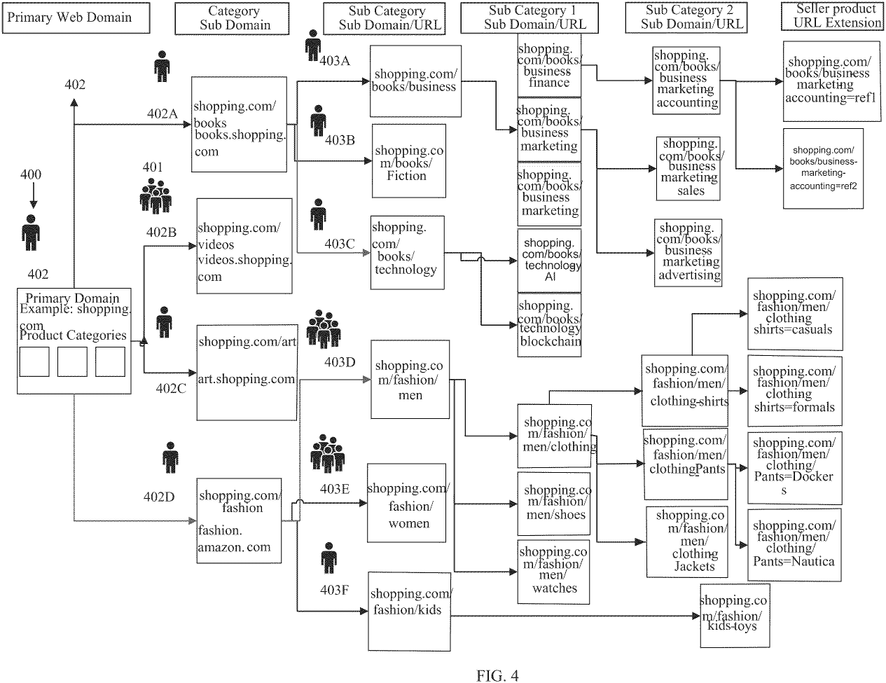

FIG. 4 illustrates an e-commerce marketplace as an example web application. The web application can also be, for example, a food/grocery delivery app, a social media platform, an informational website, a media website, an entertainment website, an educational website or any other website or a mobile application. Any of these websites can offer one or more categories of information or products or services and, for all such categories, there can be separate web pages and corresponding URL. Each web page can have an owner 400 or a group of owners 401. Again, for each category of information/product/service there can be two or more subcategories. Each of such web pages for categories or subcategories of information/product/service has different web URLs which leads to the location of a specific web page or file on the Internet. In the present example, website 402 www.shopping.com has four categories of products - category “books” 402A, category “videos” 402B, category “art” 402C and category “fashion” 402D as shown in FIG. 4. Box 402A, 402B, 402C, 402D shows two URLs for the web page of category “books” -books.example.com indicated by reference numeral 402A and example.com/books/. Web address for the web page for the category “books” can be organized under any of these two URLs. In URL books.example.com, “books” 402A is a lower-level domain (third level domain or a subdomain) under/below an upper-level domain (second level domain) “example”, and “/books/” in URL example.com/books/ is a subdirectory under second level domain “example” for the web page for the category “books”.

Present invention enables a domain/subdomain/subdirectory owner 400/401 to assign or transfer ownership of a web page corresponding to a category or subcategory of the information/products/services. In an embodiment, present invention executes such a transfer/licensing of ownership of a category/subcategory of a web page by assigning ownership of the web address or the URL (which may comprise a subdomain and/or a subdirectory) corresponding to the web page to the new owner. In the present example, the owner of 402A domain “shopping.com/books” requests for enlistment of URL books.example.com or URL example.com/books/ for sale in FIG. 4. Prospective buyers of the web page can participate in the auction and place their bid using the “Graphical User Interface” as a step after opening an account with the blockchain computing system. The computer system 102 then selects a bidder based on one or more criteria including highest bid value.

In accordance with an embodiment of the present invention, the assignment of ownership of a web page to a buyer (person or entity) for a particular category/subcategory of products and service involve associating non-fungible tokens (NFTs) with the URL (comprising subdomain and/or subdirectory) corresponding to the web page and also with the web resources linked to the web page. The method may further comprise creating/writing of a smart contract on the blockchain to programmatically define digital rights for each of the resources with respect to the ownership of the web page. Once deployed on the blockchain, the smart contract automatically executes or documents relevant events for implementing the smart contract.

The assignment of ownership of a web page in accordance with an embodiment of the present invention also involves protecting the ownership of each resource linked to the web page. A resource can be a product listing, information, art, data or a software code listed by third party sellers within the marketplace. The ownership of the web page can be independent of the ownership of the product listed on the webpage. Therefore, the blockchain computing system gathers the information related to the resources, products, services linked to the web page. In the present example FIG. 3, resource e-commerce 307 provides an e-commerce marketplace for buying and selling products. Similarly, resource text application 308 enables viewing/reading of a book and software as a service or software code 309.

The smart contract executes functions including transfer of domain, sub domain or URL and assigns ownership using NFTs and also sets the royalty sharing rules including rules for sharing royalty among all the upper level and lower level domain/subdomain/subdirectory owners in the domain hierarchy. For any transaction happening on a web page (or through its resources) of a lower-level subdomain/subdirectory, the revenue/royalty can be shared with all the upper-level subdomain/subdirectory owners as per a predefined/pre-agreed ratio. For example, for a transaction occurring on a web page of a third level domain, revenue/royalty on the transaction can be shared with the second level domain owner which is immediately above the third level domain in the domain hierarchy. This way, present invention enables generation of a revenue stream for a domain/subdomain owner by monetizing any subdomain/subdirectory under the upper-level domain/subdomain on recurring basis and not just as one-time basis revenue source against the sale/licensing of the lower-level subdomain/subdirectory. The smart contract includes all such revenue sharing instructions and, against every transaction, executes the instructions to transfer and deposit the revenue/royalty portion to the accounts of the respective domain/subdomain and associated web page owners.

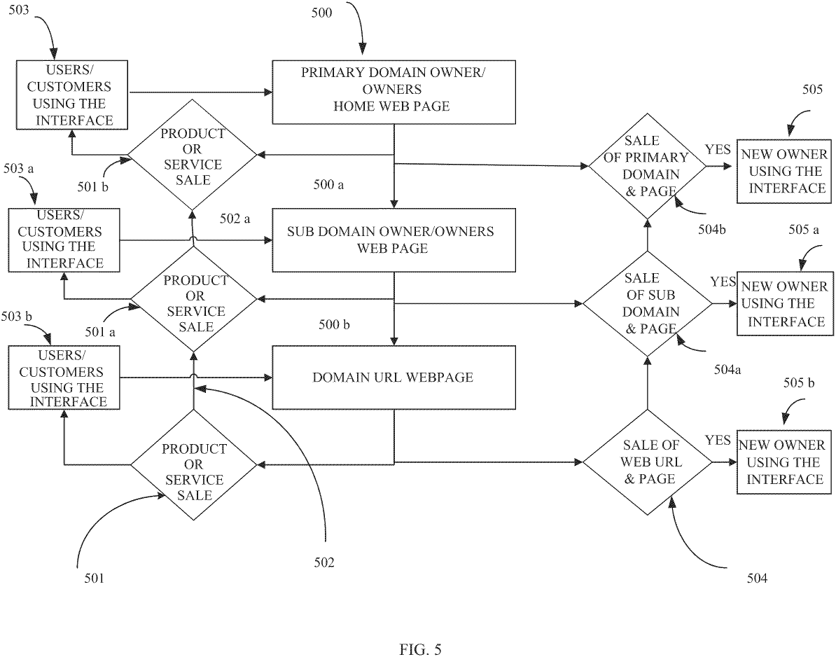

FIG. 5 illustrates a flowchart to show the user 503 accessing the interface provided by a browser or by the app on the client or customer or user devices. The customer or prospective buyer 503 can purchase products or services offered by the primary domain owner or owners 500. Both customers or prospective buyers or users and domain owners or sellers avail the services using the account maintained with the computer system 100 or on the blockchain 101. Similarly, the customers 503 a and 503 b can purchase products or services offered by primary domain owners or sub-domain owners or domain URL owners.

The blockchain smart contract, as shown in step 502 of FIG. 5, can to be used to define rules related to royalty/revenue sharing corresponding to any transaction executed against a usage of a resource as identified by a non-fungible token product or service. The royalty sharing rule may include rules for sharing royalty among all the upper level and lower level domain/subdomain/URL/subdirectory owners in the domain hierarchy. For any transaction happening on a web page (or through its resources) of a lower level domain URL 501, the revenue/royalty can be shared with all the upper level subdomain 501a owners as per a predefined/pre-agreed ratio. For example, for a transaction occurring on a web page of a domain URL 500 b, revenue/royalty on the transaction 502a can be shared with the subdomain owner 500 a which is immediately above the subdomain 500 b in the domain hierarchy. The smart contract includes all such revenue sharing instructions and, against every transaction, executes the instructions to transfer and deposit the revenue/royalty portion to the accounts of the respective domain/subdomain owners.

Continuing with the present example, a consumer using interface on a client device as in 503 of FIG. 5, wants to visit the web page owners by primary or subdomain or URL and make use of/utilizes any of its resources, product or service by paying a fee/price. Such a utilization of the web page or resources of the web page is captured corresponding to the NFT and the digital rights associated with the web page and/or the resources. The smart contract underlying the NFTs then automatically calculates the royalty/revenue amount and transfers the respective portions of the revenue against the transaction to the upper level domain owner and to the lower level domain owner as in step 502a of FIG. 5.

Present invention enables owners of a domain/subdomain/URL and underlining web page and products or services to assign ownership of a domain/subdomain/URL and underlining web page and products or services to another person/entity. In an embodiment, present invention executes such a transfer/licensing of ownership of a web page by assigning ownership of the web address or the URL (which may comprise a subdomain and/or a subdirectory) corresponding to the web page to the new owner. An account can be an entity with a crypto currency balance that can send transactions on a blockchain and an account can be controlled by a user or it can be deployed as a smart contract. The owners of primary or subdomain or domain URL can list the domain subdomain or URL and the underlining web pages for sale on the blockchain network. The blockchain module 101 of the computing system 100 accordingly enlists the URL and the underlying web pages for sale/auction as in flowchart 504 of FIG. 5. Prospective buyers of the web page can participate in the auction and place their bid using the interface as in step 505 of FIG. 5 after opening an account with the computer system 100.

What is claimed is:

1. A method for web page and web application ownership assignment, said method comprising:
assigning one or more owners, an ownership to a web page or a web application using one or more web proof of ownership technologies, said one or more web proof of ownership technologies include a digital rights management for said web page or said web application, a digital watermark on said web page or said web application, a fingerprinting on said web page or said web application, a generation of a hash from an information associated with said web page or said web application and a generation of a software code for said web page or said web application.
encrypting one or more web resources corresponding to said web page or said web application with generation of a set of encryption and decryption keys; and
pairing or tagging said web page or said web application or said web resource with a decentralized domain name service smart contract and one or more Non-Fungible Tokens.

2. The method as in claim 1, wherein said pairing or said tagging of said web page or said web resource involves pairing of a domain and a subdomain corresponding to said web page or to said web application or to said web resource.

3. The method as in claim 1, wherein said web resource comprises a product or service listings on said webpage, an advertisement on said webpage, an information content on said web page or a software running on said web page or a combination of or a set of said web pages forming a web platform, and an e-marketplace.

4. The method as in claim 2, wherein said web page corresponding to said domain or said sub-domain represents said one or more web resources.

5. The method as in claim 1, wherein said one or more owners of said webpage generate a revenue from said web page or said web resource through sale of products or services listed on said web page.

6. The method as in claim 5, wherein a smart contract is configured to programmatically define one or more rules for sharing of said revenue.

7. The method as in claim 2, wherein a sale of said domain and said subdomain results in transfer of said ownership of said web page or said web application or said web resource corresponding to said domain and said subdomain to one or more new owners.
